(19) United States
(12) Patent Application Publication
(10) Pub. No.: US 2022/0170475 A1
(43) Pub. Date: Jun. 2, 2022

(54) HERMETIC COMPRESSOR

(71) Applicant: LG ELECTRONICS INC., Seoul (KR)

(72) Inventors: Inbum Park, Seoul (KR); Kyoungjun Park, Seoul (KR); Kiyeon Lee, Seoul (KR)

(73) Assignee: LG Electronics Inc.

(21) Appl. No.: 17/482,712

(22) Filed: Sep. 23, 2021

(30) Foreign Application Priority Data
Nov. 27, 2020 (KR) 10-2020-0162990

(51) Int. Cl. F04D 29/06; F04D 25/02

(52) U.S. Cl. CPC F04D 29/06; F04D 25/02

(57) ABSTRACT

A hermetic compressor includes: a compression unit; a motor unit; a crankshaft that connects the motor unit and the compression unit; and a bearing member provided with a shaft receiving hole so as to support the crankshaft in a radial direction. An oil supply groove that defines a part of an oil supply passage is formed on an outer circumferential surface of the crankshaft, and the oil supply groove is provided between the outer circumferential surface of the crankshaft and an inner circumferential surface of the bearing member facing the outer circumferential surface of the crankshaft to be located out of pressed regions generated when the crankshaft rotates. As the oil supply groove that supplies oil to a bearing surface between the crankshaft and a main bearing is formed by avoiding the pressed regions, oil may be smoothly supplied to the bearing surface.

### CROSS-REFERENCE TO RELATED APPLICATION

Pursuant to 35 U.S.C. § 119(a), this application claims the benefit of the earlier filing date and the right of priority to Korean Patent Application No. 10-2020-0162990, filed in Korea on Nov. 27, 2020, the contents of which are incorporated by reference herein in their entirety.

### BACKGROUND

### 1. Field

The present disclosure relates to an upper compression type hermetic compressor.

### 2. Background

A hermetic compressor may be a compressor in which both a motor and a compression unit or compressor that define a compressor body are installed at an inner space of a shell. A hermetic compressor may be classified as a fixed support method type or an elastic support method type according to a method of supporting the compressor body with respect to the shell.

Hermetic compressors can also be classified into a lower compression type and an upper compression type according to a relative position between a motor unit or motor and a compression unit or compressor. In the lower compression type, a compression unit may be located below a motor unit, and in the upper compression type, a compression unit may be located above a motor unit.

The lower compression type may be suitable for oil supply since a compression unit may be located adjacent to oil stored in a shell, however, a space for installing a loop pipe may be insufficient so that it may be immersed in the oil, which may decrease oil viscosity. In contrast, the upper compression type may be disadvantageous for oil supply since a distance between a compression unit and oil may be greater than that of the lower compression type. However, a space for installing a loop pipe may be sufficient so that it may not be immersed in the oil, which may be advantageous to maintain oil viscosity.

Japanese Laid-Open Patent Application No. 2005-163775 discloses a reciprocating compressor. In the disclosed reciprocating compressor, an oil supply passage having an oil pickup is provided at a lower end of a crankshaft, and an oil supply hole and an oil supply groove in communication with the oil supply passage are formed on an outer circumferential surface of the crankshaft. Oil can be smoothly supplied to an upper end of the crankshaft as oil pumped by the oil pickup is guided to an oil path and the oil supply groove by the centrifugal force.

However, in the disclosed reciprocating compressor of Japanese Laid-Open Patent Application No. 2005-163775, as a compression or inertial load is applied to portions or parts of the oil supply hole and the oil supply groove at a main shaft of the crankshaft, the oil supply groove may be blocked to thereby reduce an amount of oil supply. Oil film thickness on the corresponding portions may be decreased, causing a friction loss to be increased, which may occur more significantly during a low-speed operation.

Japanese Laid-Open Patent Application No. 2016-75260 discloses a hermetic compressor in which an oil supply hole and an oil supply groove are formed by avoiding pressed regions or areas, such as a compression load and an inertial load, thereby reducing friction loss. However, reliability and efficiency of the disclosed compressor may be reduced due to a friction loss generated in a main shaft of a crankshaft since a part of the oil supply hole or a part of the oil supply groove of the crankshaft is still included in the pressed regions.

The above references are incorporated by reference herein where appropriate for appropriate teachings of additional or alternative details, features and/or technical background.

### BRIEF DESCRIPTION OF THE DRAWINGS

Embodiments will be described in detail with reference to the following drawings in which like reference numerals refer to like elements, and wherein:

FIG. 1 is a see-through perspective view illustrating a shell of an example reciprocating compressor;

FIG. 2 is a cross-sectional view illustrating an inside of the reciprocating compressor according to FIG. 1;

FIG. 3 is a perspective view illustrating an example of a crankshaft;

FIG. 4 is a cross-sectional view of the crankshaft of FIG. 3;

FIGS. 5A; 5B; and 5C illustrate front views of an example of crankshaft viewed from different angles;

FIG. 6 is a schematic view illustrating an unwound state of an oil supply groove of the crankshaft according to FIG. 5;

FIGS. 7A; 7B; and 7C illustrate a comparison of an oil supply groove according to the present disclosure in an unwound state with an oil supply groove according to the related art in an unwound state;

FIGS. 8A and 8B are graphs showing changes in minimum oil film thickness of a bearing and bearing friction loss at each rotation angle (crank angle) by comparing the oil supply groove according to the present disclosure with the oil supply groove according to the related art;

FIG. 9 illustrates another example of an oil supply groove in an unwound state;

FIG. 10 illustrates another example of an oil supply groove in an unwound state;

FIG. 11 illustrates another example of an oil supply groove in an unwound state; and

FIGS. 12A and 12B are cross-sectional views taken along line “IV-IV” and line “V-V” of FIG. 11.

### DETAILED DESCRIPTION

Hereinafter, a hermetic compressor according to one or more implementations of the present disclosure will be described in detail with reference to the accompanying drawings. As described above, a hermetic compressor is a compressor in which both a motor unit or motor and a compression unit or compressor that define a compressor body are installed at an inner space of a shell. The hermetic compressor can be classified into a reciprocating type, a rotary type, a vane type, a scroll type, etc. depending on a method of compressing a refrigerant, and be classified into a lower compression type and an upper compression type according to a relative position between a motor unit and a compression unit. Hereinafter, an example of an upper compression type reciprocating compressor will be mainly discussed. However, embodiments disclosed herein are not limited thereto, and the implementations disclosed herein may also be applied to any hermetic compressor equipped with an oil pump configured to pump oil stored in an inner space of a shell.

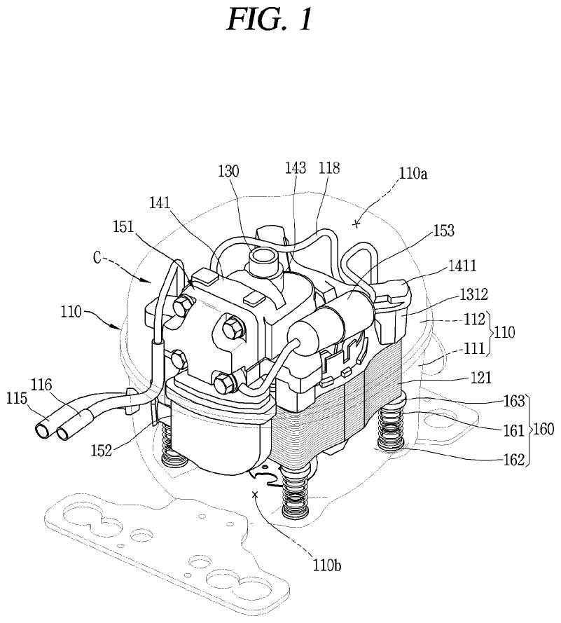

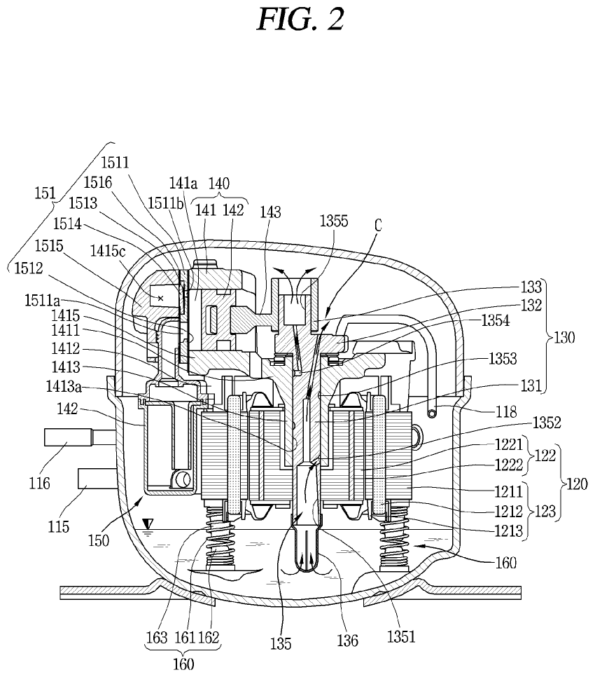

As illustrated in FIGS. 1 and 2, a reciprocating compressor includes a shell 110 that defines an outer appearance, a motor unit or motor 120 that is provided at an inner space 110a of the shell 110 to provide a driving force, a compressor 140 that compresses a refrigerant by receiving the driving force from the motor 120, a suction and discharge assembly 150 that guides a refrigerant to a compression chamber 141a and discharges a compressed refrigerant, and a support part or support 160 that supports a compressor body C including the motor 120 and the compressor 140 with respect to the shell 110.

The shell 110 may include a lower shell 111 and an upper shell 112 coupled to each other so as to define a sealed inner space 110a. The motor 120 and the compressor 140 may be provided in the inner space 110a of the shell 110. The shell 110 may be made of an aluminum alloy (hereinafter abbreviated as “aluminum”) that is lightweight and has a high thermal conductivity.

The lower shell 111 may have a substantially hemisphere shape. A suction pipe 115, a discharge pipe 116, and a process pipe may be coupled to the lower shell 111 in a penetrating manner. For example, the suction pipe 115, the discharge pipe 116, and the process pipe may be coupled to the lower shell 111 by insert die casting.

The upper shell 112 may have a substantially hemispherical shape like the lower shell 111. The upper shell 112 may be coupled to an upper portion of the base shell 111 to define the inner space 110a of the shell 110. The upper shell 112 and the lower shell 111 may be coupled by welding. As an alternative, the lower shell 111 and the upper shell 112 may be coupled by a bolt when they are made of an aluminum material that is not suitable for welding.

A description will now be given of the motor 120. As illustrated in FIGS. 1 and 2, the motor 120 may include a stator 121 and a rotor 122. The stator 121 may be elastically supported in the inner space 110a with respect to a bottom surface of the lower shell 111, and the rotor 122 may be rotatably installed inside the stator 121.

The stator 121 may include a stator core 1211 and a stator coil 1212. The stator core 1211 may be made of a metal material, such as an electrical steel sheet, and may perform electromagnetic interaction with the stator coil 1212 and the rotor 122 described hereinafter through an electromagnetic force when a voltage is applied to the motor 120 from the outside.

The stator core 1211 may have a substantially rectangular cylinder shape. For example, an inner circumferential surface of the stator core 1211 may be formed in a circular shape, and an outer circumferential surface thereof may be formed in a rectangular shape. The stator core 1211 may be fixed to a lower surface of a main bearing 141 by a stator fastening bolt.

A lower end of the stator core 1211 may be supported by a support spring 161 to be described hereinafter with respect to a bottom surface of the shell 110 in a state that the stator core 1211 is axially and radially spaced apart from an inner surface of the shell 110. The support spring 161 may prevent vibration generated during operation from being directly transferred to the shell 110.

The stator coil 1212 may be wound inside the stator core 1211. As described above, when a voltage is applied from the outside, the stator coil 1212 may generate an electromagnetic force to perform electromagnetic interaction with the stator core 1211 and the rotor 122, allowing the motor 120 to generate a driving force so that the compressor 140 may perform a reciprocating motion. An insulator 1213 may be provided between the stator core 1211 and the stator coil 1212 to prevent direct contact between the stator core 1211 and the stator coil 1212 and facilitate the electromagnetic interaction.

The rotor 122 may include a rotor core 1221 and magnets 1222. The rotor core 1221 may be made of a metal material such as an electrical steel plate and may have a same material as that of the stator core 1211. Similarly, the rotor core 1221 may have a substantially cylindrical shape. A crankshaft 130 to be described hereinafter may be press-fitted and coupled to a central part of the rotor core 1221. A main shaft 131 and an eccentric shaft 133 may be provided at both ends of the crankshaft 130 in an axial direction with respect to a plate 132, which will be described again later.

The magnets 1222 may be configured as permanent magnets and be inserted into the rotor core 1221 at equal intervals along a circumferential direction of the rotor core 1221. When a voltage is applied, the rotor 122 may be rotated by electromagnetic interaction with the stator core 1211 and the stator coil 1212. Then, the crankshaft 130 may rotate together with the rotor 122, allowing a rotational force of the motor 120 to be transferred to the compression unit 140 through a connecting rod 143.

Hereinafter, the compressor 140 will be described.

As illustrated in FIGS. 1 and 2, the compressor 140 may include the main bearing 141 and a piston 142. The main bearing 141 may be elastically supported on the shell 110, and the piston 142 may be coupled to the crankshaft 130 by the connecting rod 143 to perform a relative motion with respect to the main bearing 141.

The main bearing 141 may be provided at an upper part of the motor 120. The main bearing 141 may include a frame 1411, a fixing protrusion 1412 coupled to the stator 121 of the motor 120, a shaft receiving or accommodating portion 1413 that supports the crankshaft 130, and a cylinder 1415 that defines the compression chamber 141a. The frame 1411 may have a flat plate shape extending in a horizontal direction, or alternatively a radial plate shape by processing a portion or part of an edge excluding corners to reduce weight or thickness.

The fixing protrusion 1412 may be provided at an edge of the frame 1411. For example, the fixing protrusion 1412 may protrude from the edge of the frame 1411 toward the motor 120 in a downward direction. The main bearing 141 and the stator 121 may be coupled by a stator fastening bolt 215 to be elastically supported on the lower shell 111 together with the stator 121 of the motor 120.

The shaft receiving portion 1413 may extend from a central portion of the frame 1411 in both directions of the axial direction. A shaft receiving hole 1413a may be axially formed through the shaft receiving portion 1413 so as to allow the crankshaft 130 to penetrate therethrough, and a bush bearing may be insertedly coupled to an inner circumferential surface of the shaft receiving hole 1413a.

The plate 132 of the crankshaft 130 may be axially supported on an upper end of the shaft receiving portion 1413, and a bearing portion 1312 of the crankshaft 130 may be radially supported on an inner circumferential surface of the shaft receiving portion 1413. The crankshaft 130 may be axially and radially supported by the main bearing 141.

The cylinder 1415 may be radially eccentric from one edge of the frame 1411. The cylinder 1415 may radially penetrate through the main bearing 141 so that the piston 142 connected to the connecting rod 143 is inserted into an inner open end thereof. A valve assembly 151 constructing the suction and discharge part 150 to be described hereinafter may be inserted into an outer open end thereof.

In some implementations, the piston 142 may have a first or opened side (e.g., a rear side) that is opened and faces the connecting rod 143 and a second or closed side opposite to the first side (e.g., a front side) that is closed. The connecting rod 143 may be inserted into the rear side of the piston 142 to be rotatably coupled, and the front side of the piston 142 may define the compression chamber 141a inside the cylinder 1415 together with the valve assembly 151.

The piston 142 may be made of the same material as the main bearing 141 (e.g., an aluminum alloy) to prevent a magnetic flux from being transmitted to the piston 142 from the rotor 122. As the piston 142 may be made of the same material as the main bearing 141, the piston 142 and the main bearing (more precisely, the cylinder or cylinder block) 141 may have the same coefficient of thermal expansion. Accordingly, even when the inner space 110a of the shell 110 has a high temperature (approximately 100° C.) during operation of the hermetic compressor, interference between the main bearing 141 and the piston 142, caused by thermal expansion, may be suppressed or reduced.

Hereinafter, the suction and discharge assembly 150 will be described. As illustrated in FIGS. 1 and 2, the suction and discharge assembly 150 may include the valve assembly 151, a suction muffler 152, and a discharge muffler 153. The valve assembly 151 and the suction muffler 152 may be sequentially coupled from the outer open end of the cylinder 1415.

In some implementations, the valve assembly 151 may include a valve plate 1511, a suction valve 1512, a discharge valve 1513, a valve stopper 1514, and a discharge cover 1515.

The valve plate 1511 may have a substantially rectangular plate shape and be installed to cover a front-end surface of the main bearing 141 and/or a front open surface of the compression chamber 141a. For example, a fastening hole may be provided at each corner of the valve plate 1511 so as to be coupled to a fastening groove formed on the front-end surface of the main bearing 141 by a bolt.

The valve plate 1511 may be provided with one suction port 1511a and at least one discharge port 1511b. When the discharge port 1511b is provided in plurality, the suction port 1511a may be formed at a central portion of the valve plate 1511, and the plurality of discharge ports 1511b may be formed along a circumference of the suction port 1511a to be spaced apart by predetermined intervals or gaps.

The suction valve 1512 may be provided at a side facing the main bearing 141 with respect to the valve plate 1511. The suction valve 1512 may be bent in a direction toward the piston 142 to be opened and/or closed. The discharge valve 1513 may be provided at an opposite side of the main bearing 141 with respect to the valve plate 1511. The discharge valve 1513 may be bent in a direction that does not face the piston 142 to be opened and closed.

The valve stopper 1514 may be provided between the valve plate 1511 and the discharge cover 1515 with the discharge valve 1513 interposed therebetween. The valve stopper 1514 may be fixed by being pressed by the discharge cover 1515 when one end thereof is in contact with a fixing portion of the discharge valve 1513.

The discharge cover 1515 and the suction valve 1512 may be coupled to the front-end surface of the main bearing 141 with the valve plate 1511 interposed therebetween, allowing the compression chamber 141a to be finally covered by the discharge cover 1415. The discharge cover 1515 may also be referred to as a “cylinder cover”.

The suction muffler 152 may transfer a refrigerant suctioned through the suction pipe 115 to the compression chamber 141a of the cylinder 1415. The suction muffler 152 may be fixed by the valve assembly 151 to communicate with the suction port 1511a of the valve plate 1511.

The suction muffler 152 may be provided therein with a suction space portion. An inlet or entrance of the suction space portion communicates with the suction pipe 115 in a direct or indirect manner, and an outlet (or exit) of the suction space portion directly communicates with a suction side of the valve assembly 151.

In some implementations, the discharge muffler 153 may be installed separately from the main bearing 141. The discharge muffler 153 may be provided therein with a discharge space portion. An inlet of the discharge space portion may be connected to a discharge side of the valve assembly 151 by the loop pipe 118, and an outlet of the discharge space portion may be directly connected to the discharge pipe 116 by the loop pipe 118.

Hereinafter, the support 160 will be described. As illustrated in FIGS. 1 and 2, the supports 160 may extend between a lower surface of the motor 120 and the bottom surface of the lower shell 111 that faces the lower surface of the motor 120 to support the motor 120. For example, there may be four supports 160 to support four corners of the motor 120 with respect to the shell 110.

In some implementations, each of the supports 160 may include the support spring 161, a first spring cap 162 that supports a lower end of the support spring 161, and a second spring cap 163. Each support 160 may define a unitary support assembly made up of the support spring 161, the first spring cap 162, and the second spring cap 163, and the unitary support assemblies may be installed along a periphery or circumference of the compressor body C to be spaced apart by predetermined intervals.

The support spring 161 may be configured as a compression coil spring. The first spring cap 162 may be fixed to the bottom surface of the lower shell 111 to support the lower end of the support spring 161, and the second spring cap 163 may be fixed to a lower end of the motor 120 to support an upper end of the support spring 161. The support springs 161 may be supported by the respective first spring caps 162 and the respective second spring caps 163 so as to elastically support the compressor body C with respect to the shell 110.

The hermetic compressor may further include an oil storage space 110b and an oil pump or pickup 136. The reciprocating compressor of the example described above may operate as follows.

When power is applied to the motor 120, the rotor 122 may rotate. When the rotor 122 rotates, the crankshaft 130 coupled to the rotor 122 may rotate, causing a rotational force to be transferred to the piston 142 through the connecting rod 143. The connecting rod 143 may allow the piston 142 to perform a reciprocating motion in a front and rear direction with respect to the cylinder 1415.

When the piston 142 moves backward from the cylinder 1415, volume of the compression chamber 141a may increase. When the volume of the compression chamber 141a is increased, a refrigerant filled in the suction muffler 152 may pass through the suction valve 1512 of the valve assembly 151, and may then be suctioned into the compression chamber 141a of the cylinder 1415.

In contrast, when the piston 142 moves forward from the cylinder 1415, volume of the compression chamber 141a may decrease. When the volume of the compression chamber 141a is decreased, a refrigerant filled in the compression chamber 141a may be compressed, pass through the discharge valve 1513 of the valve assembly 151, and then be discharged to the discharge chamber 1415c of the discharge cover 1515. This refrigerant may flow into the discharge space portion of the discharge muffler 153 through the loop pipe 118 and may be then discharged to a refrigeration cycle through the loop pipe 118 and the discharge pipe 116. Such series of processes may be repeated.

Here, as the crankshaft 130 rotates, oil stored in the oil storage space 110b of the shell 110 may lubricate radial bearing surfaces B1 and B2 described hereinafter while being transferred to an upper end of the crankshaft 130 through an oil supply passage 135 provided in the crankshaft 130. This oil may lubricate the compressor 140 while being scattered at the upper end of the crankshaft 130 and cool the motor 120. Then, the oil may be recovered to the oil storage space 110b of the shell 110.

In the case of a so-called ‘upper compression type hermetic compressor’ in which the compressor 140 is located above the motor 120, the oil pump 136 may be provided at a lower end of the crankshaft 130 since oil may be pumped from the oil storage space 110b, which is provided at a lower portion of the shell 110, to be transferred to the upper end of the crankshaft 130.

In general, a gear pump to which a trochoidal gear is applied, a viscous pump to which a screw gear is applied, and a centrifugal pump to which a propeller is applied may be mainly used for the oil pump. The gear pump may be disadvantageous due to its complicated structure and high manufacturing costs. As for the viscous pump, a structure to fix a screw gear with respect to a crankshaft may be complicated, and an amount of pumping may greatly vary according to an operation speed since oil may have to pass through a long pumping passage (or path) having a spiral shape. Compared to the gear pump and viscous pump, the centrifugal pump may be relatively inexpensive and structurally simple. However, a height available for oil supply may be limited compared to the gear or viscous pump of the same size (or dimension).

An oil supply groove may be provided on an outer circumferential surface of the crankshaft so as to allow oil pumped by the oil pump to be guided to the bearing surfaces formed between an outer circumferential surface of the main shaft and an inner circumferential surface of the main bearing. However, pressed (or pressurized) portions or regions may be generated in the bearing surfaces between the main shaft and the main bearing because bearing surfaces may become narrowed by a compression load and an inertial load generated when the crankshaft rotates. When the oil supply groove passes through these pressed regions, a gap between the oil supply groove and each bearing surface may be reduced and eventually cause a blockage or clogging.

Then, a so-called ‘oil clogging (or oil stagnation)’ may occur as oil may not be able to get out of the oil supply groove. Then, oil may not flow to the bearing surfaces, and thus an amount of oil supplied to the bearing surfaces may be decreased. As a result, a thickness of oil film on the bearing surfaces may become thinner or an oil film may not be continuously formed to thereby increase a friction loss between the crankshaft and the main bearing.

This may occur more frequently when the centrifugal pump having a relatively weak or low pumping force is applied. For this reason, the gear pump or the viscous pump having a relatively high pumping force may be used for the oil pump to solve the aforementioned oil clogging to a certain degree. However, even if the gear pump or the viscous pump is applied, the oil clogging may not be fundamentally addressed. Also, since the gear pump or the viscous pump is structurally complicated and expensive, manufacturing costs of the compressor may be increased.

As such, in the present disclosure, the oil supply groove 1353 may be formed to avoid pressed regions of the bearing surfaces B1 and B2 to be described hereinafter. Accordingly, oil clogging between the oil supply groove 1353 and the bearing surface B1 and/or B2 may be suppressed or eliminated. This may result in a thick and uniform oil film thickness on the bearing surfaces B1 and B2, allowing a friction loss to be reduced. Further, a relatively inexpensive oil pump, namely, the centrifugal pump may be applied to reduce manufacturing costs of the compressor.

Referring back to FIG. 2, in the reciprocating compressor of this example, the crankshaft 130 may be rotatably coupled by penetrating through the shaft receiving hole 1413a of the main bearing 141. The oil pump 136 configured to pump oil stored in the oil storage space 110b of the shell 110 may be coupled to a lower end of the crankshaft 130, and the oil supply passage 135 may be provided inside or at the outer circumferential surface of the crankshaft 130. The crankshaft 130 may rotate at a constant speed (approximately 60 Hz) or a variable speed while being axially and/or radially supported by the main bearing 141, and the oil pump 136 may pump oil stored in the oil storage space 110b while rotating together with the crankshaft 130, allowing the oil to flow or move toward the upper end of the crankshaft 130 through the oil supply passage 135. A centrifugal pump may be used for the oil pump 136.

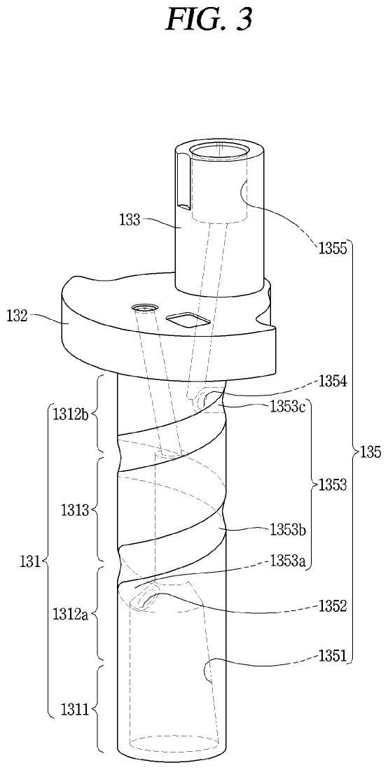

As illustrated in FIGS. 2 and 3, the crankshaft 130 may include the main shaft 131, the plate 132, and the eccentric shaft 133. A portion or part of the main shaft 131 may be inserted into the shaft receiving hole 1413a to be supported in the radial direction, and thus the main shaft 131 may be slightly smaller than an inner diameter of the shaft receiving hole 1413a. The radial bearing surfaces (hereinafter abbreviated as “bearing surface”) B1 and B2 may be formed between an outer circumferential surface of the main shaft 131 and an inner circumferential surface of the shaft receiving hole 1413a. However, when the main shaft 131 entirely defines the bearing surfaces, a friction area may be excessively increased. Thus, the bearing surfaces may be respectively formed on both sides to be spaced apart in the axial direction by a predetermined interval.

The main shaft 131 may include a rotor coupling portion 1311, the bearing portion 1312, and a gap or clearance portion 1313. The rotor coupling portion 1311 to which the rotor 122 is press-fitted may define a lower end of the main shaft 131 (or a lower end portion of the crankshaft 130) and may be located axially outward of the main bearing 141. The rotor coupling portion 1311 may be provided therein with a first hollow hole or space 1351 to be described hereinafter, and an outer circumferential surface thereof may be formed flat with a smooth tube shape.

The bearing portion 1312 that forms the bearing surfaces B1 and B2 may be rotatably inserted into the shaft receiving hole 1413a. The bearing portion 1312 may be divided into a lower bearing portion 1312a and an upper bearing portion 1312b. The lower bearing portion 1312a and the upper bearing portion 1312b may be axially spaced apart from each other by the gap portion 1313.

An outer circumferential surface of the lower bearing portion 1312a may form a first bearing surface B1 with an inner circumferential surface of the receiving hole 1413a. An axial length of the first bearing surface B1 may be less (i.e., shorter) than an axial length of the gap portion 1313. A length of a first oil supply groove portion 1353a to described hereinafter may be less than a length of a second oil supply groove portion 1353b.

The lower bearing portion 1312a may extend upward from the lower half of the main shaft 131 (or an upper end of the rotor coupling portion 1311) along the axial direction by a predetermined length. The lower bearing portion 1312a may be provided at a lower middle part or potion of the crankshaft 130.

A first oil supply hole 1352 that penetrates from the first hollow hole 1351 in a radial direction may be provided at a middle part of the lower bearing portion 1312a, and the first oil supply groove portion 1353a that extends from the first oil supply hole 1352 may be formed in the outer circumferential surface of the lower bearing portion 1312a.

An outer circumferential surface of the upper bearing portion 1312b may form a second bearing surface B2 with the inner circumferential surface of the shaft receiving hole 1413a. An axial length of the second bearing surface B2 may be shorter than the axial length of the gap portion 1313. A length of a third oil supply groove portion 1353c to be described hereinafter may be less than a length of the second oil supply groove portion 1353b.

The upper bearing portion 1312b may extend downward from the upper half of the main shaft 131 or a lower end of the plate 132 along the axial direction by a predetermined length. The upper bearing portion 1312b may be provided at an upper middle part of the crankshaft 130.

A third oil supply groove portion 1353c that extends from a second oil supply hole 1354 may be provided at the outer circumferential surface of the upper bearing portion 1312b, and the second oil supply hole 1354 that radially penetrates from the third oil supply groove portion 1353c toward a second hollow hole or space 1355 may be provided at a middle part of the upper bearing portion 1313b. The first hollow hole 1351 may communicate with the second hollow hole 1355 through the first oil supply hole 1352, the first oil supply groove portion 1353a, the second oil supply groove portion 1353b, the third oil supply groove portion 1353c, and the second oil supply hole 1354.

The gap portion 1313 may be provided between a lower end of the rotor coupling portion 1311 and an upper end of the bearing portion 1312. An outer diameter of the gap portion 1313 may be less than an outer diameter of the lower bearing portion 1312a and an outer diameter of the upper bearing portion 1312b. An outer circumferential surface of the gap portion 1313 may be spaced apart from the inner circumferential surface of the shaft receiving hole 1413a of the main bearing 141 by a predetermined interval which is greater than an interval of the bearing surfaces B1 and B2. A bearing surface may not be formed between the outer circumferential surface of the gap portion 1313 and the shaft receiving hole 1413a.

However, if the outer diameter of the gap portion 1313 is too small relative to the inner diameter of the shaft receiving hole 1413a, an interval between the gap portion 1313 and the shaft receiving hole 1413a may be greatly increased. Then, oil may not be suctioned up smoothly along the second oil supply groove portion 1353b. The gap portion 1313 may have an outer diameter smaller than an inner diameter of the shaft receiving hole 1413a, and the outer diameter thereof may be as large as possible within a range that does not form a bearing surface.

The plate 132 on the upper end of the main shaft 131 may be axially supported on an axial bearing surface of the main bearing 141, and may radially extend past the inner diameter of the shaft receiving hole 1413a. The plate 132 may be provided therein with the second hollow hole 1355. A portion or part of the second hollow hole 1355 may penetrate in the axial direction or in a direction inclined with respect to the axial direction.

The eccentric shaft 133 that converts a rotational force of a drive motor into a reciprocating motion of the piston 142 may extend from the plate 132 to an opposite side of the main shaft 131 and be eccentric with respect to an axial center of the main shaft 131. The remaining portion of the second hollow hole 1355 may be formed in the eccentric shaft 133 and penetrate in the axial direction or in a direction inclined with respect to the axial direction up to an end thereof. The second hollow hole 1355 may be provided in the eccentric shaft 133 in a communicating manner by passing through the upper bearing portion 1312b and the plate 132.

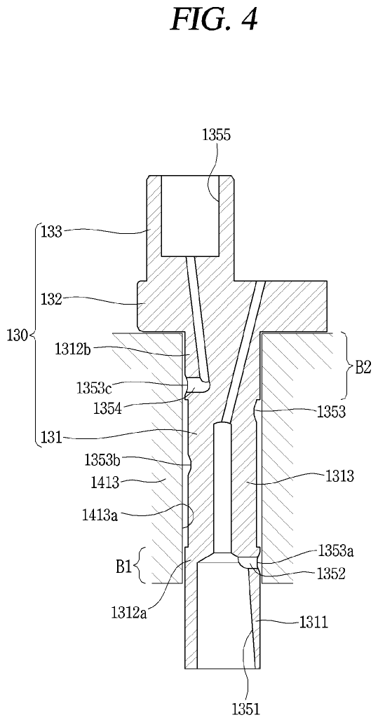

Referring to FIGS. 3 and 4, in some implementations, the oil supply passage 135 may be formed in the order of the first hollow hole 1351, the first oil supply hole 1352, the oil supply groove 1353, the second oil supply hole 1354, and the second hollow hole 1355. The first oil supply hole 1352 and the second oil supply hole 1354 may penetrate between the first hollow hole 1351 and the oil supply groove 1353, and between the second hollow hole 1355 and the oil supply groove 1353, respectively. The oil supply groove 1353 may be formed on the outer circumferential surface of the crankshaft 130 to connect the first oil supply hole 1352 and the second oil supply hole 1354.

For convenience of description, the first hollow hole 1351 and the second hollow hole 1355 will be described first, the first oil supply hole 1352 and the second oil supply hole 1354 will be described after, and the oil supply groove 1353 will be described last.

In some implementations, the first hollow hole 1351 may be formed through an inside of the crankshaft 130 by a predetermined length. The first hollow hole 1351 may penetrate from the lower end of the rotor coupling portion 1311 that defines the lower end of the main shaft 131 to an upper surface of the plate 132.

The first hollow hole 1351 may be inclined with respect to the axial direction. Here, a lower end of the first hollow hole 1351 that defines an inlet (or entrance) thereof may be formed on the same center with respect to a center of the main shaft 131. The first hollow hole 1351 may have a wide inner diameter. The lower end of the first hollow hole 1351 that defines the inlet thereof may be eccentric with respect to the center of the main shaft 131. A rotation radius of the first hollow hole 1351 may be increased, allowing a dynamic pressure of oil to be enhanced.

In some implementations, the first hollow hole 1351 may be formed in the axial direction. For example, the first hollow hole 1351 may be formed such that its lower end defining the inlet and its upper end defining an outlet may extend along the same axis. Here, the upper end of the first hollow hole 1351 may extend to an intermediate height of the lower bearing portion 1312a.

The first hollow hole 1351 may be formed on a same center or alternatively be eccentric with respect to the center of the main shaft 131. For example, when the first hollow hole 1351 is formed on the same center with respect to the center of the main shaft 131, the first hollow hole 1351 may have a maximum inner diameter while achieving a minimum thickness of the crank shaft 130 in consideration of its strength. An amount of oil introduced may be increased.

On the other hand, when the first hollow hole 1351 is eccentric with respect to the center of the main shaft 131, a dynamic pressure of pumped oil may be increased by expanding or increasing a rotation radius of the first hollow hole 1351. An amount of oil supply may be increased while increasing a minimum thickness of the crankshaft 130.

In some implementations, the first hollow hole 1351 may have a single or constant inner diameter that is the same between the lower end and the upper end thereof, or alternatively may vary to have a plurality of different inner diameters. For example, the first hollow hole 1351 may be gradually narrowed to the upper end from the lower end or near the lower end thereof. Here, strength of the main shaft 131 may be enhanced while allowing a cross-sectional area of an inlet side of the first hollow hole 1351 to be expanded or increased. The first hollow hole 1351 may have multiple ends and may have other various shapes.

In some implementations, the second hollow hole 1355 may be formed through an inside of the crankshaft 130 by a predetermined length, which may be the same as the predetermined length of the first hollow hole 1351. However, unlike the first hollow hole 1351, which is provided at the lower end of the crankshaft 130, the second hollow hole 1355 may be formed at the upper end of the crankshaft 130.

The second hollow hole 1355 may penetrate from an upper end of the eccentric shaft 133 and the plate 132 to an intermediate position of the upper bearing portion 1312b.

The second hollow hole 1355 may be formed in the axial direction or alternatively may be inclined with respect to the axial direction, like the first hollow hole 1351. In addition, the second hollow hole 1355 may have a single or constant inner diameter or alternatively may vary to have a plurality of inner diameters.

As the second hollow hole 1355 is formed ranging from the eccentric shaft 133 to the main shaft 131 that have different central axes, a portion or part of the second hollow hole 1355 may be formed in the axial direction, and a remaining portion thereof may be inclined to the axial direction. For example, an upper part of the second hollow hole 1355 may be formed up to an intermediate height of the eccentric shaft 133 in the axial direction, and a lower part of the second hollow hole 1355 may be formed in an inclined manner up to an intermediate height of the upper bearing portion 1312b where the second oil supply hole 1354 is located.

Here, the upper part of the second hollow hole 1355 may be wider than a lower part of the second hollow hole 1355. The second hollow hole 1355 may be formed ranging from the eccentric shaft 133 to the main shaft 131 that have the different central axes while achieving a minimum or reduced thickness of the crankshaft 130 in consideration of its strength. However, the upper part of the second hollow hole and the lower part of the second hollow hole may be collectively referred to as the second hollow hole 1355 for sake of convenience.

In some implementations, the first oil supply hole 1352 may penetrate or be formed from a middle or adjacent to the middle portion of the first hollow hole 1351 toward the outer circumferential surface of the main shaft 131 (or the outer circumferential surface of the lower bearing portion 1312a). The first oil supply hole 1352 may penetrate in the radial direction. However, in some cases, the first oil supply hole 1352 may have other various shapes, such as an inclined shape.

In some implementations, the second oil supply hole 1354 may penetrate or be formed from a lower end or adjacent to the lower end of the second hollow hole 1355 toward the outer circumferential surface of the main shaft 131 (or the outer circumferential surface of the upper bearing portion 1312b). The second oil supply hole 1354 may penetrate in the radial direction. However, the second oil supply hole 1354 may have other various shapes, such as an inclined shape.

In some implementations, the oil supply groove 1353 may be formed on the outer circumferential surface of the main shaft 131 so as to provide connection between the first oil supply hole 1352 and the second oil supply hole 1354. The oil supply groove 1353 may be configured as a single groove, or a plurality of grooves. For the sake of convenience, as one first oil supply hole 1352 and one second oil supply hole 1354 are provided, a case in which the oil supply groove 1353 is configured as one groove will be mainly discussed.

Both ends (an end at the first oil supply hole 1352 and an end at the second oil supply hole 1354) of the oil supply groove 1353 may have a same cross-sectional area, or may have different cross-sectional areas. For example, the oil supply groove 1353 may have one circumferential width or depth, or may have a plurality of circumferential widths or depths. Hereinafter, an example in which the both ends of the oil supply groove 1353 have the same cross-sectional area will be described first, and an example of having different cross-sectional areas will be described later.

Hereinafter, when classification or division of the oil supply groove 1353 is not required, the oil supply groove 1353 will be collectively referred to as the oil supply groove 1353. When the classification or division is required for description, the oil supply groove 1353 will be classified into different portions or sections such as the first oil supply groove portion 1353a, the second oil supply groove portion 1353b, and the third oil supply groove portion 1353c. For example, a portion of the oil supply groove 1353 corresponding to the lower bearing portion 1312a may be referred to as the first oil supply groove portion 1353a, a portion of the oil supply groove 1353 corresponding to the gap portion 1313 may be referred to as the second oil supply groove portion 1353b, and a portion of the oil supply groove 1353 corresponding to the upper bearing portion 1312b may be referred to as the third oil supply groove 1353c.

The oil supply groove 1353 may be divided along a flow path of oil. An end portion at the first oil supply hole 1352 will be referred to as a first end P1, and an end portion at the second oil supply hole 1354, which may be at the opposite side, will be referred to as a second end P2. With respect to the flow path of oil, the first end P1 will be defined as an upstream side and the second end P2 will be defined as a downstream side.

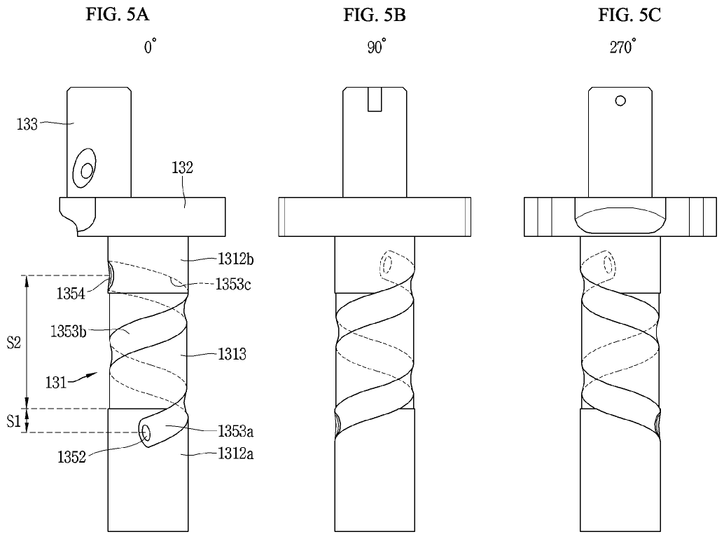

As illustrated in FIG. 5, the oil supply groove 1353 may be spirally wrapped or wound from the lower half of the main shaft 131 toward the upper half thereof. The oil supply groove 1353 may be wound approximately 1.7 turns from the first oil supply hole 1352 that defines the first end P1 to the second oil supply hole 1354 that defines the second end P2. This may be approximately 630° in terms of a crank angle (rotation angle).

FIG. 5A illustrates a state in which the crank angle is 0°, that is when the eccentric shaft 133 is located farthest away from the cylinder (or compression chamber) 1415. FIG. 5B illustrates a state in which the crank angle is 90°. FIG. 5C illustrates a state in which the crank angle of 270°. FIG. 5B and FIG. 5C have a phase difference of 180°. Although not illustrated in the drawings, it has a phase difference of 180° with respect to FIG. 5A when the eccentric shaft 133 is located closest to the cylinder 1415.

The oil supply groove 1353 may have a linear shape when unwound or spread out according to rotation angles. In some implementations, the oil supply groove 1353 may have a so-called ‘two-step inclination (or tilt) angles’ in which the inclination angle is changed at an intermediate point of the oil supply groove 1353.

For example, the oil supply groove 1353 may have a linear shape with an inflection point P3 between the first end P1 and the second end P2. The inflection point P3 may be formed at or around a point where the lower bearing portion 1312a and the gap portion 1313 substantially meet. The oil supply groove 1353 may be provided outside of a pressed region, allowing oil clogging or oil stagnation between the oil supply groove 1353 and the first bearing surface B1 or the second bearing surface B2 to be suppressed or eliminated.

Hereinafter, the inclination angle will be defined as an angle at which the oil supply groove 1353 is inclined in a direction orthogonal to the axial direction (e.g., the radial direction, a transverse direction, or a compressor installation surface).

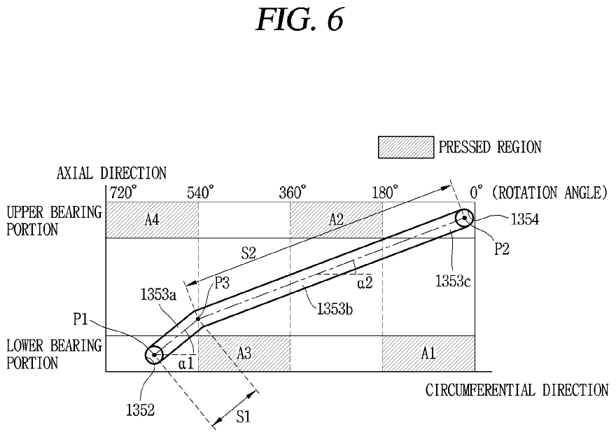

As illustrated in FIG. 6, the oil supply groove 1353 may be divided into a first oil supply section S1 that is from the first end (first oil supply hole) P1 to a specific crank angle that forms the inflection point P3, and a second oil supply section S2 that is from the specific crank angle to the second end (second oil supply hole) P2. An inclination angle α1 of the first oil supply section S1 may be greater than an inclination angle α2 of the second oil supply section S2.

The main shaft 131 of the crankshaft 130 may be formed such that the lower bearing portion 1312a and the upper bearing portion 1312b are spaced apart by the gap portion 1313, and the eccentric shaft 133 may be provided at an upper portion of the main shaft 131 to be eccentric with respect to the axial center thereof, as described above. The lower bearing portion 1312a and the upper bearing portion 1312b form pressed regions with a phase difference of approximately 180°.

As described above, when a crank angle of a point where the eccentric shaft 133 is located farthest away from the cylinder (or compression chamber) 1415 is 0°, and a crank angle of a point where the eccentric shaft 133 is located closest to the cylinder 1415 is 180°, the piston 142 may perform one compression stroke and one expansion stroke per rotation (cycle) of the crankshaft 130.

Here, during the compression stroke, a gas reaction force may be acted on the eccentric shaft 133. Then, the lower bearing portion 1312a located relatively far from the eccentric shaft 133 may receive a compression load, causing pressed regions A1 and A3. In contrast, during the expansion stroke, an action force may be acted on the eccentric shaft 133 by the drive motor constructing the motor 120. Then, the upper bearing portion 1312b located relatively adjacent to the eccentric shaft 133 may receive an inertial load, causing pressed regions A2 and A4.

Referring to FIG. 6, from 0° to 180° in the rotation direction, the first pressed region A1 may be formed by the lower bearing portion 1312a, from 180° to 360°, the second pressed region A2 may be formed by the upper bearing portion 1312b, from 360° to approx. 520° to 560° (e.g., 540°), the third pressed region A3 may be caused by the lower bearing portion 1312a, and from 540° to 630°, the fourth pressed region A4 may be caused by the upper bearing portion 1312b.

In some implementations, the oil supply groove 1353 may be formed such that the inclination angle of the first oil supply section S1 defining the upstream side, with respect to the order of oil supplied, is greater than the inclination angle of the second oil supply section S2 defining the downstream side. Here, the first oil supply section S1 may be defined as a section from 630°, which is the first end P1 of the oil supply groove 1353, to 540°, which is a specific crank angle forming the inflection point P3. The oil supply section S2 may be defined as a section from the specific crank angle of 540° to 0°, which is the second end P2 of the oil supply groove 1353.

Also, the inclination angle of the oil supply section (or first oil supply groove portion) S1 with respect to the radial direction (or transverse direction) of the crankshaft 130 may be defined as a first inclination angle (or an upstream inclination angle) α1, and the second oil supply section (or the second and third oil supply groove portions) S2 may be defined as a second inclination angle (or a downstream inclination angle with respect to the order of oil flow) α2.

In this case, as described above, the first inclination angle α1, which is the inclination angle of the first oil supply section S1, may be greater than the second inclination angle α2, which is the inclination angle of the second oil supply section S2. The first inclination angle (or the upstream inclination angle) α1 between 630° of an inlet end (a first end of the oil supply groove) of the first oil supply section (or the first oil supply groove portion) S1 and 540° (the specific crank angle) which is the inflection point P3 of the oil supply groove 1353 may be greater than the second inclination angle (the downstream inclination angle) α2 between 540° (the specific crank angle) defining the inlet end (the inflection point) of the second oil supply section (or the second and third oil supply groove portions) S2 and 0° which is an outlet end (a second end of the oil supply groove) of the second oil supply section S2.

For example, the first inclination angle α1 may be approximately 30 to 50°, and the second inclination angle α2 may be approximately 10 to 20°. The first inclination angle α1 may be approximately two times or greater than the second inclination angle α2.

However, a ratio of the first inclination angle α1 to the second inclination angle α2 may vary according to a position of the first end (or the first oil supply hole) P1 and a specific crank angle position. For example, when the first end P1 of the oil supply groove 1353 is located greater than 630°, an angle of the first inclination angle α1 may need to be decreased. In contrast, when the first end P1 of the oil supply groove 1353 is located less than 630°, the angle of the first inclination angle α1 may need to be increased.

In addition, if the specific crank angle, namely, the inflection point P3, is located greater than 540°, an angle of the first inclination angle α1 should be increased. Also, the angle of the first inclination angle α1 may be increased when the specific crank angle is less than 540°. Therefore, the specific crank angle, which is the inflection point P3, may be set at 540°, namely, the upper end of the lower bearing portion 1312a that forms a point of contact with the gap portion 1313.

The crankshaft 130 may be provided therein with the first hollow hole 1351 and the second hollow hole 1355 respectively formed at both axial ends thereof, and the oil supply groove 1353 having both ends connected to the first oil supply hole 1352 and the second oil supply hole 1354 in communication with the first hollow hole 1351 and the second hollow hole 1355, respectively, may be provided on the outer circumferential surface of the crankshaft 130.

The first inclination angle α1 for the first oil section S1 from the first end P1 defining the lower end of the oil supply groove 1353 to the specific crank angle P3 which is the inflection point P3 may be greater than the second inclination angle α2 for the second oil supply section S2 from the specific crank angle to the second end P2 defining the upper end of the oil supply groove 1353.

Through the oil supply passage of the example described above, oil may flow as follows. Oil stored in a bottom portion of the shell 110 may be suctioned into the first hollow hole 1351 by a centrifugal force generated when the crankshaft 130 rotates. The oil introduced into the first hollow hole 1351 may flow to the oil supply groove 1353 through the first oil supply hole 1352.

Oil may flow along the oil supply groove 1353, move to the second oil supply hole 1354, and flow to the second hollow hole 1355 through the second oil supply hole 1354. Then, the oil may be scattered from the upper end of the crankshaft 130 toward the inner space 110a of the shell 110 through the second hollow hole 1355.

Here, part (or some) of the oil flowing to the oil supply groove 1353 through the first oil supply hole 1352 may form an oil film between the outer circumferential surface of the lower bearing portion 1312a and the inner circumferential surface of the shaft receiving hole 1413a facing it at the first oil groove portion 1353a that defines a portion or part of the oil supply groove 1353 to thereby lubricate the lower bearing portion 1312a.

The oil passing through the first oil supply groove portion 1353a may pass through the second oil supply groove portion 1353b that defines another portion of the oil supply groove 1353 and flows to the third oil supply groove portion 1353c that defines another portion of the oil supply groove 1353. As the third oil supply groove portion 1353c is formed on the outer circumferential surface of the upper bearing portion 1312b, part of the oil introduced into the third oil supply groove portion 1353c may form an oil film between the outer circumferential surface of the upper bearing portion 1312b and the inner circumferential surface of the shaft receiving hole 1413a facing it to thereby lubricate the upper bearing portion 1312b.

A compression load and an inertial load may act on the lower bearing portion 1312a and the upper bearing portion 1312b of the crankshaft 130 when the crankshaft 130 rotates. Due to these compression load and the inertial load, the lower bearing portion 1312a and the upper bearing portion 1312b may alternately form pressed regions.

When the oil supply groove 1353 passes through the pressed regions, a communication area of the first bearing surface B1 between the oil supply groove 1353 and the lower bearing portion 1312a, or the second bearing surface B2 between the oil supply groove 1353 and the upper bearing portion 1312b, may be reduced. Then, oil in the oil supply groove 1353 may not smoothly flow to the first bearing surface B1 of the lower bearing portion 1312a, or the second bearing surface B2 of the upper bearing portion 1312b, causing ‘oil clogging’ described above.

However, in this example, the oil supply groove 1353 may be configured as a ‘two-step oil supply groove’ in which the first inclination angle α1 of the first oil supply section S1 defining the oil supply groove 1353 is greater than the second inclination angle α2 of the second oil supply section S2. The oil supply groove 1353 in the first oil supply section S1 and the second oil supply section S2 may avoid all of the first to fourth pressed regions A1 to A4 generated due to a compression load or an inertial load.

The oil supply groove 1353 may not be formed on the bearing portion 1312 in a crank angle range in which each of the pressed regions is formed to thereby sufficiently obtain or secure the communication area between the oil supply groove 1351 and the bearing surface B1, and the communication area between the oil supply groove 1351 and the bearing surface B2. Oil clogging that prevents oil in the oil supply groove 1353 from flowing out to the bearing surfaces B1 and B2 during operation of the compressor (especially, a low-speed operation) may be suppressed or addressed. This may allow oil to smoothly flow to the bearing surfaces B1 and B2 to thereby form a wide and thick oil film.

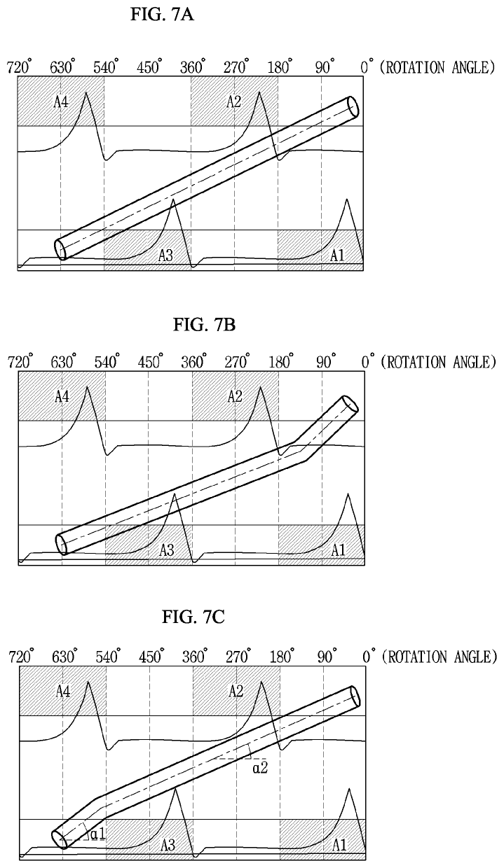

Referring to FIGS. 7A; 7B; and 7C, in the related art 1 [FIG. 7A], an oil supply groove has a single inclination angle. In the related art 2 [FIG. 7B], an oil supply groove has a plurality of inclination angles where a first inclination angle α1 is less than a second inclination angle α2, unlike the present disclosure, which is shown by FIG. 7C. In both the related art 1 and the related art 2 (7A and 7B), a first oil supply section S1, namely, a first oil supply groove portion overlaps a pressed region (third pressed region) A3.

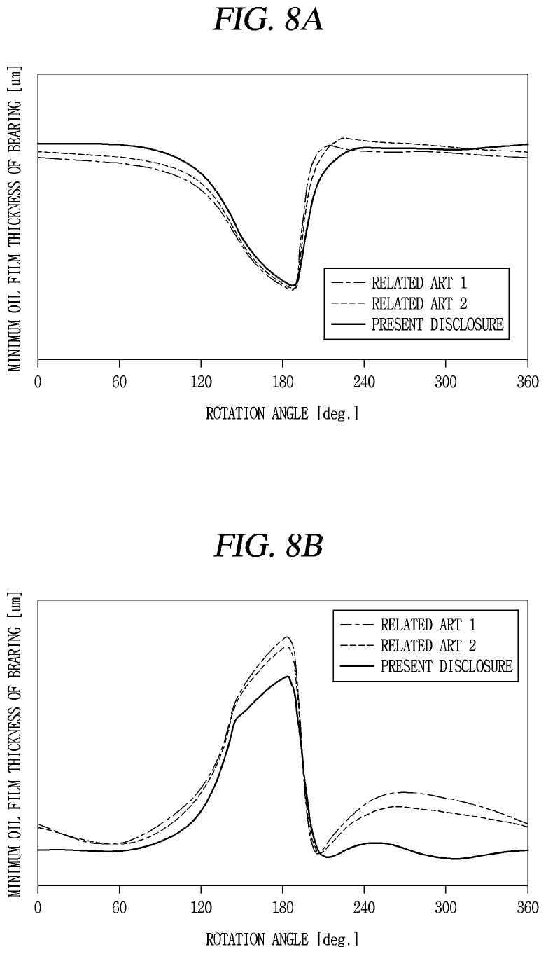

Referring to FIG. 8A, the present disclosure exhibits an increased minimum oil film thickness of the bearing than the related art 1 and the related art 2 except at some rotational angle sections. As can be seen from FIG. 8B, a bearing friction loss may be significantly reduced in the present disclosure compared to the related art 1 and the related art 2.

This is because the entire sections of the oil supply groove 1353 in the preset disclosure may be formed so as not to overlap each of the pressed regions. Oil clogging due to a compression or inertial load generated during operation of the compressor may be reduced or prevented so that oil can be smoothly supplied regardless of a rotational speed of the crankshaft.

As the oil supply groove 1353 may be provided out of the pressed regions A1, A2, A3, and A4, oil in the oil supply groove 1351 may be smoothly supplied to the bearing surfaces B1 and B2, allowing a relatively inexpensive centrifugal pump to be applied to the lower end of the crankshaft 130. This may result in reducing manufacturing costs of the compressor.

Hereinafter, a description will be given of another example of an oil supply passage according to the present disclosure. In the example described above, the second oil supply groove portion and the third oil groove portion that define the second oil supply section may have one inclination angle, but in some cases, the second oil supply groove portion and the third oil groove portion may be configured to have different inclination angles.

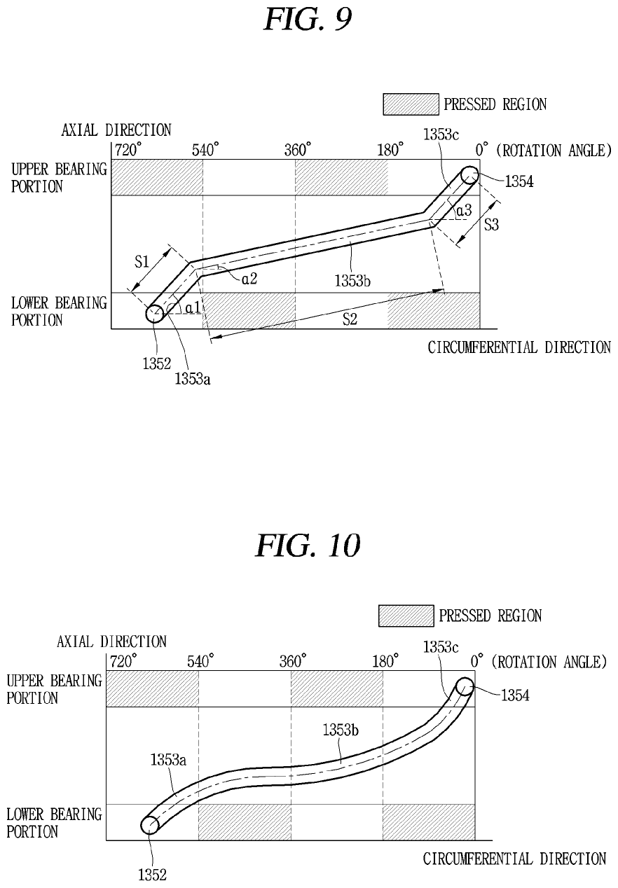

As illustrated in FIG. 9, the oil supply groove 1353 according to this example may be configured as one groove that is connected to each portion of the main shaft 131, i.e., the lower bearing portion 1312a, the gap portion 1314, and the upper bearing portion 1312b, as in the example described above. For the sake of convenience, a portion of the oil supply groove 1353 formed in the lower bearing portion 1312a will be referred to as the first oil supply groove portion 1353a, a portion of the oil supply groove 1353 formed in the gap portion 1313 will be referred to as the second oil supply groove portion 1353b, and a portion of the oil supply groove 1353 formed in the upper bearing portion 1312b will be referred to as the third oil supply groove portion 1353c.

More specifically, in the oil supply groove 1353 according to this example, a first inclination angle α1 of the first oil supply groove portion 1353a that defines a first oil supply section S1 may be greater than a second inclination angle α2 of the second oil supply groove portion 1353b that defines a second oil supply section S2, and the second inclination angle α2 of the second oil supply groove portion 1353b may be less than a third inclination angle α3 of the third oil supply groove portion 1353c that defines a third oil supply section S3. The first inclination angle α1 of the first oil supply groove portion 1353a and the third inclination angle α3 of the third oil supply groove portion 1353c may be greater than the second inclination angle α2 of the second oil supply groove portion 1353b.

The first inclination angle α1 of the first oil supply groove portion 1353a may be equal to or slightly greater than the third inclination angle α3 of the third oil supply groove portion 1353c. For example, the first inclination angle α1 of the first oil supply groove portion 1353a may be approximately 30 to 50°, which is the same as that of the example described above, and the third inclination angle α3 of the third oil supply groove portion 1353c may be 40 to 60°. The first inclination angle α1 of the first oil supply groove portion 1353a may be less than the third inclination angle α3 of the third oil supply groove portion 1353c. The upstream side in which oil is introduced may be located out of a pressed region while reducing the inclination angle as much as possible, allowing oil to be smoothly introduced.

As the third oil supply groove portion 1353c defines the downstream side, oil may flow smoothly due to pressure of the oil sucked from the upstream side even when the third inclination angle α3 of the third oil supply groove portion 1353c is slightly greater than the first inclination angle α1 of the first oil supply groove portion 1353a and the second inclination angle α2 of the second oil supply groove portion 1353b. A basic configuration and effects of the oil supply groove according to this example are similar to those of the previous example of FIG. 6, and thus a detailed description thereof will be omitted. However, in this example, as the third inclination angle α3 of the third oil supply groove portion 1353c is greater than the second inclination angle α2 of the second oil supply groove portion 1353b, the second oil supply groove portion 1353b may be formed with a gentle slope. Even during a low-speed operation, oil may be suctioned up relatively smoothly from the second oil supply groove portion 1353b having a relatively long groove portion length.

Hereinafter, a description will be given of another example of an oil supply passage according to the present disclosure. In the examples described above, the first oil supply groove portion defining the first oil supply section and the second and third oil groove portions defining the second oil supply section may be formed in a linear shape, but in some cases, at least one of the first oil supply groove portion, the second oil supply groove portion, and the third oil supply groove portion may have a curved shape.

As illustrated in FIG. 10, the oil supply groove 1353 according to this example may have the same cross-sectional area along a lengthwise direction. However, in the oil supply groove 1353 according this example, at least one oil supply groove portion may have a curved shape. The oil supply groove 1353 may be formed outside of each pressed region.

For example, the first oil supply groove portion 1353a may be curved enough to avoid the third pressed region A3. Compared to the example of FIG. 6, the oil supply groove portion 1353 of this example is rounded to be convex in a rotation direction of the crankshaft 130.

As the convexly rounded portion of the first oil supply groove portion 1353a is deviated from an edge of the third pressed region A3, the first oil supply groove portion 1353a may not overlap the third pressed region A3 generated by a compression load during operation of the compressor. Even if the first bearing surface B1 between the outer circumferential surface of the lower bearing portion 1312a and the inner circumferential surface of the shaft receiving hole 1413a facing the outer circumferential surface of the lower bearing portion 1312a becomes excessively close to each other, the oil supply section S1 may bypass the third pressed region A3 generated by this, thereby preventing or reducing oil clogging in the oil supply groove 1353.

The second oil supply groove portion 1353b or the third oil supply groove portion 1353c defining the second oil supply section S2 may also have a curved shape. For example, the second oil groove portion 1353b may have a radius of curvature greater than a radius of curvature of the first oil supply groove portion 1353a, and the third oil groove portion 1353c may have a radius of curvature smaller than the radius of curvature of the second oil supply groove portion 1353b, namely, the radius of curvature of the third oil groove portion 1353c substantially similar to that of the first oil supply groove portion 1353a.

The first oil supply groove portion 1353a may avoid an edge of the third pressed region A3, and the third oil supply groove portion 1353c may be deviated from an edge of the second pressed region A2. The oil supply groove 1353 may bypass the pressed regions, generated by the compression load during operation of the compressor, without overlapping them to prevent or reduce oil clogging in the oil supply groove 1353.

As at least a portion or part of the oil supply groove 1353 (i.e., a part between the first oil supply groove portion 1353a and the second oil supply groove portion 1353b forming an inflection point) has a curved shape, the oil supply groove 1353 at the inflection point may be formed with a gentle slope. A flow path of oil may not change rapidly, allowing the oil to flow smoothly.

The first oil supply groove portion 1353a may be formed in a curved shape, while the second oil supply groove portion 1353b and the third oil supply groove portion 1353c may be formed in a linear shape as in the example of FIG. 6. This has been described in the example of FIG. 6, so a detailed description thereof will be omitted.

Hereinafter, a description will be given of another example of an oil supply passage. In the examples described above, the first inclination angle of the first oil supply section is greater than the inclination angle of the second oil supply section, but in some cases, the inclination angle of the first oil supply section and the inclination angle of the second oil supply section may be equal. In this case, a cross-sectional area of the first oil supply section and a cross-sectional area of the second oil supply section may be the same, or the cross-sectional area of the first oil supply section may be greater than the cross-sectional area of the second oil supply section.

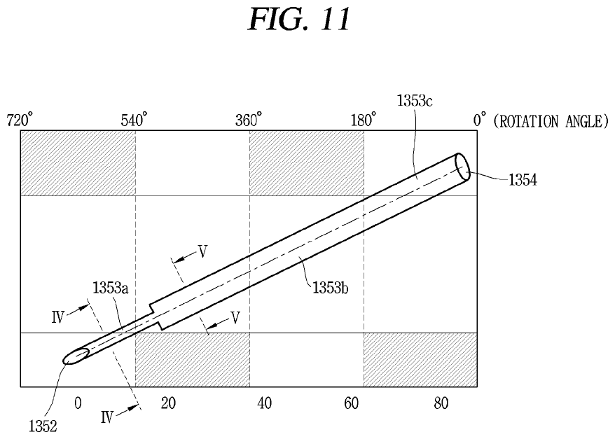

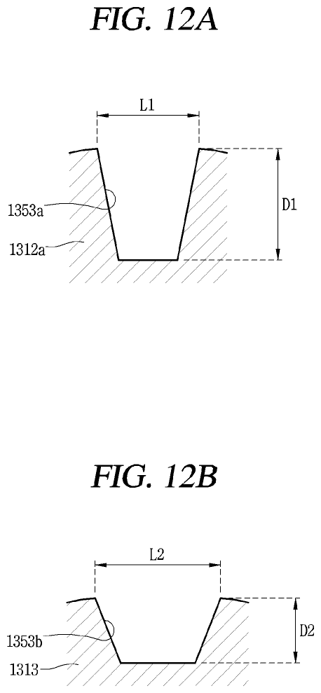

As illustrated in FIGS. 11 to 12B, the oil supply groove 1353 according to this example may have a linear shape when unwound, but a cross-sectional area may be the same along a lengthwise direction of the oil supply groove 1351. For example, a width L1 of the first oil supply groove portion 1353a defining the first oil supply section S1 may be less than a width L2 of the second oil supply groove 1353b defining the second oil supply section S2. Up to a part of the second oil supply section S2 in contact with the first oil supply section S1 may be equal to the width L1 of the first oil supply section S1. The oil supply groove 1353 may have a linear shape or similar to a linear shape while allowing the first oil supply section S1 from being deviated from the third pressed region A3.

However, in this case, a depth D1 of the first oil supply section S1 may be greater or deeper than a depth D2 of the second oil supply section S2. Even when the width L1 of the first oil supply section S1 is less than the width L2 of the second oil supply section S2, the cross-sectional area of the first oil supply section S1 may be equal to or substantially equal to the cross-sectional area of the second oil supply section S2.

In the example of FIGS. 11 to 12B, the oil supply groove 1353 may have a linear shape, and the oil supply groove 1353 may be provided outside of the pressed regions A1 to A4, or have a smaller section included in the pressed regions A1 to A4. Flow resistance of oil flowing along the oil supply groove 1353 may be reduced, allowing the oil to be smoothly supplied to the bearing surfaces even in a low-speed operation.

Embodiments disclosed herein may provide a hermetic compressor that can suppress a friction loss by uniformly forming an oil film on a bearing surface between a crankshaft and a main bearing that supports the crankshaft with an appropriate thickness. Embodiments disclosed herein may provide a hermetic compressor that can allow oil in an oil supply groove to be smoothly supplied to a bearing surface between a crankshaft and a main bearing that supports the crankshaft to thereby uniformly form an oil film on a bearing surface with an appropriate thickness.

Embodiments disclosed herein may provide a hermetic compressor that can allow oil to be smoothly supplied to a bearing surface without causing oil clogging in an oil supply groove that supplies oil to the bearing surface between a crankshaft and a main bearing by forming the oil supply groove out of pressed regions.

Embodiments disclosed herein may provide a hermetic compressor that can allow oil in an oil supply groove to be smoothly supplied to a bearing surface even when a part of the oil supply groove to supply the oil to the bearing surface between a crankshaft and a main bearing is included in pressed regions. Embodiments disclosed herein may provide a hermetic compressor that can reduce manufacturing costs of the compressor by reducing costs for an oil pump. Embodiments disclosed herein may provide a hermetic compressor that can allow oil in an oil storage space to be transferred to an upper end of a crankshaft while employing a relatively inexpensive centrifugal pump.

Embodiments disclosed herein may provide a hermetic compressor that can use a centrifugal pump that is inexpensive but has a relatively low pumping force for an oil pump by allowing oil pumped by the oil pump to be smoothly transferred along an oil supply passage without causing clogging.

Embodiments disclosed herein may provide an oil supply groove that guides oil stored in a shell to a bearing surface may be provided on an outer circumferential surface of a crankshaft. The oil supply groove may be formed such that oil passing through the oil supply groove may smoothly flow to a bearing surface between the outer circumferential surface of the crankshaft and an inner circumferential surface of a main bearing facing the outer circumferential surface of the crankshaft. An oil film with an appropriate thickness may be uniformly or evenly formed on the bearing surface between the crankshaft and the main bearing that supports the crankshaft, thereby suppressing a friction loss.

The oil supply groove may be formed at a position out of a region or area where the outer circumferential surface of the crankshaft and the inner circumferential surface of the main bearing facing the outer circumferential surface of the crankshaft are in close contact. Oil in the oil supply groove may be smoothly supplied to the bearing surface between the crankshaft and the main bearing that supports the crankshaft without causing clogging. An oil film of an appropriate thickness may be uniformly formed on the bearing surface.

The oil supply groove may have two-step inclination angles with a greater (larger) inclination angle at the upstream side so as to be out of a pressed region in which the outer circumferential surface of the crankshaft and the inner circumferential surface of the main bearing that supports the crankshaft are in close contact. As the oil supply groove that supplies oil to the bearing surface between the crankshaft and the main bearing is located out of the pressed region, oil in the oil supply groove may be smoothly supplied to the bearing surface without causing clogging.

A part or portion of the oil supply groove may be included in a pressed region in which the outer circumferential surface of the crankshaft and the inner circumferential surface of the main bearing that supports the crankshaft are in close contact, and the part included in the pressed region may have a larger cross-sectional area than other parts. Even if the part of the oil supply groove is included in the pressed region, more oil may be contained due to its wide cross-sectional area, and oil may be smoothly supplied to the bearing surface.

An oil pump to pump oil stored in a shell may be installed at a lower end of a crankshaft. The oil pump may be configured as a centrifugal pump. Costs for the oil pump may be reduced to thereby reduce manufacturing costs of the compressor.

Embodiments disclosed herein may provide an oil supply groove that communicates with an oil pump and guides oil stored in an oil storage space of a shell to a bearing surface. The oil supply groove may be formed at a position out of a region where an outer circumferential surface of the crankshaft and an inner circumferential surface of a main bearing facing the outer circumferential surface of the crankshaft are in close contact to allow a centrifugal pump that is relatively inexpensive to be employed while allowing oil in the oil storage space to be smoothly transferred to an upper end of the crankshaft.

The oil supply groove may have two-step inclination angles with a larger inclination angle at an upstream side to be located out of a region where an outer circumferential surface of the crankshaft and an inner circumferential surface of a main bearing facing the outer circumferential surface of the crankshaft are in close contact, or a part of the oil supply groove may be included in a pressed region in which the outer circumferential surface of the crankshaft and the inner circumferential surface of the main bearing that supports the crankshaft are in close contact, and the part included in the pressed region may have a larger cross-sectional area than other parts. Oil pumped by the oil pump may be smoothly transferred along the oil supply passage without causing clogging. A centrifugal pump having a relatively weak pumping force may be used for the oil pump.

Embodiments disclosed herein may provide a first hollow hole and a second hollow hole located above the first hollow hole in an axial direction may be provided. A first oil supply hole penetrating from the first hollow hole to an outer circumferential surface of a crankshaft and a second oil supply hole penetrating from the second hollow hole to the circumferential surface of the crankshaft and located above the first oil supply hole in the axial direction may be formed. An oil supply groove that connects the first oil supply hole and the second oil supply hole may be formed on the outer circumferential surface of the crankshaft. The oil supply groove may be provided between the outer circumferential surface of the crankshaft and an inner circumferential surface of a bearing member facing the outer circumferential surface of the crankshaft to be located out of pressed regions generated when the crankshaft rotates. Oil in the oil supply groove may be smoothly supplied to a bearing surface by preventing oil clogging in the pressed regions during operation of the compressor.

The crankshaft may be provided with a lower bearing portion that forms a first bearing surface with the bearing member and an upper bearing portion that forms a second bearing surface with the bearing member. The lower bearing portion and the upper bearing portion may be spaced apart in an axial direction. Portions or parts of the oil supply groove may be formed on an outer circumferential surface of the lower bearing portion and an outer circumferential surface of the upper bearing portion, respectively. An inclination angle of the oil supply groove formed on the lower bearing portion may be greater than an inclination angle of the oil supply groove formed on the upper bearing portion. The oil supply groove may have two-step inclination angles and be located out of a pressed region of the bearing surface defined by the lower bearing portion.

The pressed regions may be alternately generated on the first bearing surface and the second bearing surface with a phase difference of 180°, and the oil supply groove may be located at an outside of the pressed regions in a circumferential direction of the first bearing surface and the second bearing surface. The oil supply groove may be formed by avoiding the pressed regions.

The crankshaft may include a main shaft part coupled to a motor unit or motor and an eccentric shaft part or shaft that extends from an end portion of the main shaft part and is eccentric with respect to an axial center of the main shaft part. An upper end of the oil supply groove may be located on an axial line at a crank angle of 0°, when the crank angle at a point in which the eccentric shaft part is located farthest away from the compression chamber is 0°. An inflection point may be formed in a 520° to 560° range of the crank angle in a direction toward a lower end of the oil supply groove. The oil supply groove may have different inclination angles with respect to the inflection point. A portion of the oil groove at the first oil supply section, which has a relatively short axial length, may be located out of one of the pressed regions.

An inclination angle at the lower end of the oil supply groove may be greater than an inclination angle at the upper end of the oil supply groove with respect to the inflection point. The oil supply groove may be formed in a shape of having two-step inclination angles, allowing the oil supply groove to be located out of the pressed regions.

Embodiments disclosed herein may provide a crankshaft, which may be provided with a first hollow hole and a second hollow hole located above the first hollow hole in an axial direction, a first oil supply hole that penetrates from the first hollow hole to the outer circumferential surface thereof and a second oil supply hole that penetrates from the second hollow hole to the outer circumferential surface thereof and located above the first oil supply hole in the axial direction. An oil supply groove that connects the first oil supply hole and the second supply hole may be formed on the outer circumferential surface of the crankshaft. The oil supply groove may include a first oil supply section from the first oil supply hole to a specific point, and a second oil supply section from the specific point to the second oil supply hole. An inclination angle of the first oil supply section and an inclination angle of the second oil supply section may be different. A cross-sectional area of the first oil supply section may be the same as a cross-sectional area of the second oil supply section. As the oil supply groove has the same cross-sectional area, the oil supply groove may be easily processed or fabricated while avoiding the pressed regions.

Embodiments disclosed herein may provide a crankshaft, which may be provided with a first hollow hole and a second hollow hole located above the first hollow hole in an axial direction, a first oil supply hole that penetrates from the first hollow hole to the outer circumferential surface thereof and a second oil supply hole that penetrates from the second hollow hole to the outer circumferential surface thereof and located above the first oil supply hole in the axial direction. An oil supply groove that connects the first oil supply hole and the second supply hole may be formed on the outer circumferential surface of the crankshaft. The oil supply groove may include a first oil supply section from the first oil supply hole to a specific point, and a second oil supply section from the specific point to the second oil supply hole. An inclination angle of the first oil supply section may be equal to an inclination angle of the second oil supply section. A width of the first oil supply section may be less than a width of the second oil supply section, and a depth of the first oil supply section may be greater than a depth of the second oil supply section. The oil supply groove may have a linear shape and be located out of the pressed regions to allow oil to be smoothly supplied to the bearing surfaces and the oil supply groove to be easily processed.

The oil supply groove may be divided into a first oil supply section that extends from one end of the oil supply groove to a specific first point, a second oil supply section that extends from the first oil supply section to a specific second point, and a third oil supply section that extends from the second oil supply section to another end of the oil supply groove. An inclination angle of the first oil supply section may be less than an inclination angle of the third oil supply section. This arrangement may allow the oil supply groove to be formed out of the pressed regions, and an inclination angle at the portion with a relatively long path length to be decreased. Oil may be smoothly supplied even during a low-speed operation.

Embodiments disclosed herein may store oil in a sealed inner space of a shell. A motor unit or motor that provides a driving force may be provided at the inner space of the shell. A compression unit configured to compress a refrigerant while being operated by the driving force of the motor unit may be provided at the inner space of the shell. The motor unit and the compression unit may be connected by a crankshaft. A shaft receiving hole may be formed in a bearing member so as to support the crankshaft in a radial direction. The crankshaft may be provided with a first hollow hole and a second hollow hole located above the first hollow hole in an axial direction, a first oil supply hole that penetrates from the first hollow hole to the outer circumferential surface thereof and a second oil supply hole that penetrates from the second hollow hole to the outer circumferential surface thereof and located above the first oil supply hole in the axial direction. An oil supply groove that connects the first oil supply hole and the second supply hole formed on the outer circumferential surface of the crankshaft.

The oil supply groove may include a first oil supply section from the first oil supply hole to a specific point, and a second oil supply section from the specific point to the second oil supply hole. An inclination angle of the first oil supply section may be greater than an inclination angle of the second oil supply section. An inlet of the first oil supply section may be located adjacent to one of the pressed regions without overlapping the pressed region, and an amount of oil supply in the first oil supply section may be secured.

A width and a depth of the first oil supply section are the same as a width and a depth of the second oil supply section to allow the oil supply groove to be out of the pressed regions, and facilitate processing of the oil supply groove.

A width of the first oil supply section may be less than a width of the second oil supply section, and a depth of the first oil supply section may be greater than a depth of the second oil supply section to allow the oil supply groove to have a linear shape while avoiding the pressed regions.

The crankshaft may include a main shaft part or shaft, a plate part or plate, and an eccentric shaft part or shaft. The main shaft part may be inserted into a shaft receiving hole. The plate part may be provided on an end of the main shaft part to be greater than an inner diameter of the shaft receiving hole. The eccentric shaft part may extend from the plate part to an opposite side of the main shaft part and be eccentric with respect to an axial center of the main shaft part.

The main shaft part may include a lower bearing portion, an upper bearing portion, and a gap portion. The lower bearing portion may extend from a lower half of the main shaft part along the axial direction by a predetermined length and include a first oil supply groove portion that defines the first oil supply hole and a part of the oil supply groove. The upper bearing portion may extend from an upper half of the main shaft part along the axial direction by a predetermined length and include a third oil supply groove portion that defines the second oil supply hole and a part of the oil supply groove. The gap portion may be provided between the lower bearing portion and the upper bearing portion, have an outer diameter less than an outer diameter of the lower bearing portion and an outer diameter of the upper bearing portion, and include a second oil supply groove portion formed on an outer circumferential surface thereof so as to connect the first oil supply groove portion and the third oil supply groove portion. The first oil supply groove portion that defines an inlet of the oil supply groove may be provided out of one of the pressed regions.

In some implementations, an inclination angle of the first oil supply groove portion may be greater than an inclination angle of the second oil supply groove portion and an inclination angle of the third oil supply groove portion. The first oil supply may be located out of one of the pressed regions.

An inclination angle of the first oil supply groove portion may be two times or greater than an inclination angle of the second oil supply groove portion and an inclination angle of the third oil supply groove portion. As the inclination angle of the first oil supply groove portion is greater than the inclination angles of the other oil supply groove portions, the first oil supply groove may be located out of one of the pressed regions.

At least a part the oil supply groove may have a linear shape when unwound in a rotation direction of the crankshaft to allow the oil groove to be easily processed while avoiding the pressed regions.

At least a part of the oil supply groove may have a curved shape when unwound in a rotation direction of the crankshaft. The oil supply groove may be provided out of the pressed regions and be formed with a gentle slope to thereby allow oil to flow smoothly.

An oil pump may be provided at an end of the crankshaft so as to pump oil stored in the inner space of the shell. The oil pump may be configured as a centrifugal pump. This arrangement may allow oil to be smoothly supplied to each of the bearing surfaces and costs for the oil pump to be reduced.

Embodiments disclosed herein may be implemented as a hermetic compressor comprising a shell forming an inner space, a compression unit provided in the inner space and having a piston and a compression chamber, a motor configured to provide a driving force to the compression unit to compress a refrigerant, a crankshaft that connects the motor and the compression unit, and a bearing provided with a shaft receiving hole so as to support the crankshaft in a radial direction. An outer surface of the crankshaft may include an oil supply groove that defines a part of an oil supply passage. The oil supply groove may face an inner surface of the bearing. The oil supply groove may be positioned to be outside of pressed regions generated when the crankshaft rotates, the pressed regions configured to receive a load during compression.

A lower portion of the crankshaft may be configured to form a first bearing surface with the bearing. An upper portion of the crankshaft may be configured to form a second bearing surface with the bearing. The lower portion and the upper portion being spaced apart in an axial direction of the crankshaft. A first portion of the oil supply groove may be formed in the lower portion. A second portion of the oil supply groove may be formed in the upper portion. An inclination angle of the first portion may be greater than an inclination angle of the second portion.

During compression, the pressed regions may be alternately generated on the first bearing surface and the second bearing surface with a phase difference of 180°, and the oil supply groove may be positioned to be outside of the pressed regions in a circumferential direction of the crankshaft.

The crankshaft may include a main shaft coupled to the motor, and an eccentric shaft that extends from an end of the main shaft and may be eccentric with respect to an axial center of the main shaft. An upper end of the oil supply groove may be located on an axial line at a crank angle of 0°, the crank angle of 0° indicating when the eccentric shaft may be located farthest away from the compression chamber. An inflection point may be formed in a range of 520° to 560° of the crank angle in a direction toward a lower end of the oil supply groove. The oil supply groove may have different inclination angles with respect to the inflection point. An inclination angle of the oil supply groove at the lower end may be greater than an inclination angle of the oil supply groove at the upper end with respect to the inflection point.

An interior of the crankshaft may be provided with a first hollow space and a second hollow space provided above the first hollow space in an axial direction of the crankshaft. A first oil supply hole may be formed from the first hollow space to the outer surface of the crankshaft. A second oil supply hole may be formed from the second hollow space to the outer surface of the crankshaft, the second oil supply hole being provided above the first oil supply hole in the axial direction of the crankshaft.

The oil supply groove may connect the first oil supply hole and the second supply hole. The oil supply groove may include a first oil supply section formed from the first oil supply hole to a predetermined position. The oil supply groove may include a second oil supply section from the predetermined position to the second oil supply hole. An inclination angle of the first oil supply section and an inclination angle of the second oil supply section may be different. A cross-sectional area of the first oil supply section may be equal to a cross-sectional area of the second oil supply section.

An interior of the crankshaft may be provided with a first hollow space and a second hollow space provided above the first hollow hole in an axial direction of the crankshaft. A first oil supply hole may be formed from the first hollow hole to the outer surface of the crankshaft. A second oil supply hole may be formed from the second hollow hole to the outer surface of the crankshaft, the second oil supply hole being provided above the first oil supply hole in the axial direction of the crankshaft.

The oil supply groove may connect the first oil supply hole and the second supply hole. The oil supply groove may include a first oil supply section from the first oil supply hole to a predetermined position. The oil supply groove may include a second oil supply section from the predetermined position to the second oil supply hole. An inclination angle of the first oil supply section may be equal to an inclination angle of the second oil supply section. A width of the first oil supply section may be less than a width of the second oil supply section. A depth of the first oil supply section may be greater than a depth of the second oil supply section.

The oil supply groove may include a first oil supply section that extends from a first end of the oil supply groove to a predetermined first position, a second oil supply section that extends from the predetermined first position to a predetermined second position, and a third oil supply section that extends from the predetermined second position to a second end of the oil supply groove. An inclination angle of the first oil supply section may be less than an inclination angle of the third oil supply section.

Embodiments disclosed herein may be implemented as a hermetic compressor comprising a shell having a sealed inner space in which oil may be stored, a motor provided in the inner space of the shell to provide a driving force, a compression unit provided in the inner space of the shell and configured to compress a refrigerant when operated by a driving force of the motor, the compression unit having a compression chamber and a piston, a crankshaft that connects the motor unit and the compression unit, and a bearing having with a shaft receiving hole to support the crankshaft in a radial direction. An interior of the crankshaft may be provided with a first hollow space and a second hollow space spaced apart from the first hollow space in an axial direction. The crankshaft may include a first oil supply hole formed from the first hollow hole to an outer surface of the crank shaft and a second oil supply hole formed from the second hollow hole to the outer surface of the crankshaft and spaced apart from the first oil supply hole in the axial direction of the crankshaft. An oil supply groove may be formed on the outer surface of the crankshaft to connect the first oil supply hole and the second supply hole. The oil supply groove may include a first oil supply section from the first oil supply hole to a predetermined position and a second oil supply section from the predetermined position to the second oil supply hole. An inclination angle of the first oil supply section may be greater than an inclination angle of the second oil supply section.

A width and a depth of the first oil supply section may be equal to a width and a depth, respectively, of the second oil supply section.

A width of the first oil supply section may be less than a width of the second oil supply section, and a depth of the first oil supply section may be greater than a depth of the second oil supply section.

The crankshaft may include a main shaft inserted into the shaft receiving hole of the bearing, a plate provided on an end of the main shaft, the plate having a cross-sectional area that may be greater than a cross-sectional area of the shaft receiving hole so as not to fit in the shaft receiving hole, and an eccentric shaft that extends from a side of the plate opposite a side of the plate that faces the main shaft, the eccentric shaft being eccentric with respect to an axial center of the main shaft. The main shaft may include a first portion having a first predetermined length along the axial direction of the crankshaft, the first portion including the first oil supply hole and a first part of the oil supply groove, a second portion that extends along the axial direction by a second predetermined length and may include the second oil supply hole and a second part of the oil supply groove, and a gap portion provided between the first and second portions, the gap portion having an outer diameter less than an outer diameter of the first portion and an outer diameter of the second portion. The gap portion may include a third part of the oil supply groove connecting the first and second parts.

An inclination angle of the first part of the oil supply groove may be greater than an inclination angle of the second part of the oil supply groove and an inclination angle of the third part of the oil supply groove.

An inclination angle of the first part of the oil supply groove may be two times or greater than an inclination angle of the second part of the oil supply groove and an inclination angle of the third part of the oil supply groove.

At least a portion of the oil supply groove may have a linear shape when unwound in a rotation direction of the crankshaft. At least a portion of the oil supply groove may have a curved shape when unwound in a rotation direction of the crankshaft.

An oil pump may be provided at an end of the crankshaft and may be configured to pump oil stored in the inner space of the shell, the oil pump being configured as a centrifugal pump.

Embodiments disclosed herein may be implemented as a hermetic compressor comprising a shell, a compression unit provided inside of the shell and having a piston and a compression chamber, a motor configured to provide a driving force to the compression unit to compress a refrigerant, a crankshaft that connects the motor and the compression unit, an outer surface of the crankshaft including an oil supply groove, and a bearing configured to surround the crankshaft to support the crankshaft in a radial direction. The oil supply groove may be positioned to be circumferentially outside of pressed regions generated when the crankshaft rotates. The pressed regions may be configured to alternately receive a load during compression via contact with the bearing.

The crankshaft may include a main shaft on which the oil supply groove may be formed and an eccentric shaft extending from the main shaft. An axial center of the eccentric shaft may be radially outside of an axial center of the main shaft.

A first end of the oil supply groove may include a first hole. A second end of the oil supply groove may include a second hole. The first and second holes may be in fluid communication with an interior of the crankshaft.

The present disclosure may be implemented in various forms without departing from the spirit or essential characteristics thereof, and thus the implementations described above should not be limited by the detailed description provided herein.

Moreover, even if any implementation is not specifically disclosed in the foregoing detailed description, it should be broadly construed within the scope of the technical spirit, as defined in the accompanying claims. Furthermore, all modifications and variations that fall within the metes and bounds of the claims, or equivalents of such metes and bounds are therefore intended to be embraced by the appended claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A hermetic compressor, comprising:
a shell forming an inner space;
a compression unit provided in the inner space and having a piston and a compression chamber;
a motor configured to provide a driving force to the compression unit to compress a refrigerant;
a crankshaft that connects the motor and the compression unit; and
a bearing provided with a shaft receiving hole so as to support the crankshaft in a radial direction, wherein:
an outer surface of the crankshaft includes an oil supply groove that defines a part of an oil supply passage,
the oil supply groove faces an inner surface of the bearing, and
the oil supply groove is positioned to be outside of pressed regions generated when the crankshaft rotates, the pressed regions configured to receive a load during compression.

2. The compressor of claim 1, wherein:
a lower portion of the crankshaft is configured to form a first bearing surface with the bearing,
an upper portion of the crankshaft is configured to form a second bearing surface with the bearing, the lower portion and the upper portion being spaced apart in an axial direction of the crankshaft,
a first portion of the oil supply groove is formed in the lower portion,
a second portion of the oil supply groove is formed in the upper portion, and
an inclination angle of the first portion is greater than an inclination angle of the second portion.

3. The compressor of claim 2, wherein, during compression, the pressed regions are alternately generated on the first bearing surface and the second bearing surface with a phase difference of 180°, and the oil supply groove is positioned to be outside of the pressed regions in a circumferential direction of the crankshaft.

4. The compressor of claim 1, wherein the crankshaft comprises:
a main shaft coupled to the motor; and
an eccentric shaft that extends from an end of the main shaft and is eccentric with respect to an axial center of the main shaft, wherein:
an upper end of the oil supply groove is located on an axial line at a crank angle of 0°, the crank angle of 0° indicating when the eccentric shaft is located farthest away from the compression chamber,
an inflection point is formed in a range of 520° to 560° of the crank angle in a direction toward a lower end of the oil supply groove, and
the oil supply groove has different inclination angles with respect to the inflection point.

5. The compressor of claim 4, wherein an inclination angle of the oil supply groove at the lower end is greater than an inclination angle of the oil supply groove at the upper end with respect to the inflection point.

6. The compressor of claim 1, wherein:
an interior of the crankshaft is provided with a first hollow space and a second hollow space provided above the first hollow space in an axial direction of the crankshaft;
a first oil supply hole is formed from the first hollow space to the outer surface of the crankshaft;
a second oil supply hole is formed from the second hollow space to the outer surface of the crankshaft, the second oil supply hole being provided above the first oil supply hole in the axial direction of the crankshaft;
the oil supply groove connects the first oil supply hole and the second supply hole;
the oil supply groove includes a first oil supply section formed from the first oil supply hole to a predetermined position;
the oil supply groove includes a second oil supply section from the predetermined position to the second oil supply hole;
an inclination angle of the first oil supply section and an inclination angle of the second oil supply section are different; and
a cross-sectional area of the first oil supply section is equal to a cross-sectional area of the second oil supply section.

7. The compressor of claim 1, wherein:
an interior of the crankshaft is provided with a first hollow space and a second hollow space provided above the first hollow hole in an axial direction of the crankshaft;
a first oil supply hole is formed from the first hollow hole to the outer surface of the crankshaft;
a second oil supply hole is formed from the second hollow hole to the outer surface of the crankshaft, the second oil supply hole being provided above the first oil supply hole in the axial direction of the crankshaft;
the oil supply groove connects the first oil supply hole and the second supply hole;
the oil supply groove includes a first oil supply section from the first oil supply hole to a predetermined position;
the oil supply groove includes a second oil supply section from the predetermined position to the second oil supply hole;
an inclination angle of the first oil supply section is equal to an inclination angle of the second oil supply section;
a width of the first oil supply section is less than a width of the second oil supply section; and
a depth of the first oil supply section is greater than a depth of the second oil supply section.

8. The compressor of claim 1, wherein the oil supply groove includes:
a first oil supply section that extends from a first end of the oil supply groove to a predetermined first position;
a second oil supply section that extends from the predetermined first position to a predetermined second position; and
a third oil supply section that extends from the predetermined second position to a second end of the oil supply groove, wherein an inclination angle of the first oil supply section is less than an inclination angle of the third oil supply section.

9. A hermetic compressor, comprising:
a shell having a sealed inner space in which oil is stored;
a motor provided in the inner space of the shell to provide a driving force;
a compression unit provided in the inner space of the shell and configured to compress a refrigerant when operated by a driving force of the motor, the compression unit having a compression chamber and a piston;
a crankshaft that connects the motor unit and the compression unit; and
a bearing having with a shaft receiving hole to support the crankshaft in a radial direction, wherein:
an interior of the crankshaft is provided with a first hollow space and a second hollow space spaced apart from the first hollow space in an axial direction,
the crankshaft includes a first oil supply hole formed from the first hollow hole to an outer surface of the crank shaft and a second oil supply hole formed from the second hollow hole to the outer surface of the crankshaft and spaced apart from the first oil supply hole in the axial direction of the crankshaft,
an oil supply groove is formed on the outer surface of the crankshaft to connect the first oil supply hole and the second supply hole,
the oil supply groove includes a first oil supply section from the first oil supply hole to a predetermined position and a second oil supply section from the predetermined position to the second oil supply hole, and
an inclination angle of the first oil supply section is greater than an inclination angle of the second oil supply section.

10. The compressor of claim 9, wherein a width and a depth of the first oil supply section is equal to a width and a depth, respectively, of the second oil supply section.

11. The compressor of claim 9, wherein a width of the first oil supply section is less than a width of the second oil supply section, and a depth of the first oil supply section is greater than a depth of the second oil supply section.

12. The compressor of claim 9, wherein the crankshaft comprises:
a main shaft inserted into the shaft receiving hole of the bearing;
a plate provided on an end of the main shaft, the plate having a cross-sectional area that is greater than a cross-sectional area of the shaft receiving hole so as not to fit in the shaft receiving hole; and
an eccentric shaft that extends from a side of the plate opposite a side of the plate that faces the main shaft, the eccentric shaft being eccentric with respect to an axial center of the main shaft, wherein the main shaft comprises:
a first portion having a first predetermined length along the axial direction of the crankshaft, the first portion including the first oil supply hole and a first part of the oil supply groove;
a second portion that extends along the axial direction by a second predetermined length and includes the second oil supply hole and a second part of the oil supply groove; and
a gap portion provided between the first and second portions, the gap portion having an outer diameter less than an outer diameter of the first portion and an outer diameter of the second portion, wherein the gap portion includes a third part of the oil supply groove connecting the first and second parts.

13. The compressor of claim 12, wherein an inclination angle of the first part of the oil supply groove is greater than an inclination angle of the second part of the oil supply groove and an inclination angle of the third part of the oil supply groove.

14. The compressor of claim 12, wherein an inclination angle of the first part of the oil supply groove is two times or greater than an inclination angle of the second part of the oil supply groove and an inclination angle of the third part of the oil supply groove.

15. The compressor of claim 12, wherein at least a portion of the oil supply groove has a linear shape when unwound in a rotation direction of the crankshaft.

16. The compressor of claim 12, wherein at least a portion of the oil supply groove has a curved shape when unwound in a rotation direction of the crankshaft.

17. The compressor of claim 9, wherein an oil pump is provided at an end of the crankshaft and is configured to pump oil stored in the inner space of the shell, the oil pump being configured as a centrifugal pump.

18. A hermetic compressor, comprising:
a shell;
a compression unit provided inside of the shell and having a piston and a compression chamber;
a motor configured to provide a driving force to the compression unit to compress a refrigerant;
a crankshaft that connects the motor and the compression unit, an outer surface of the crankshaft including an oil supply groove; and
a bearing configured to surround the crankshaft to support the crankshaft in a radial direction, wherein the oil supply groove is positioned to be circumferentially outside of pressed regions generated when the crankshaft rotates, the pressed regions configured to alternately receive a load during compression via contact with the bearing.

19. The hermetic compressor of claim 18, wherein the crankshaft includes a main shaft on which the oil supply groove is formed and an eccentric shaft extending from the main shaft, an axial center of the eccentric shaft being radially outside of an axial center of the main shaft.

20. The hermetic compressor of claim 18, wherein a first end of the oil supply groove includes a first hole, a second end of the oil supply groove includes a second hole, and the first and second holes are in fluid communication with an interior of the crankshaft.
